(19) United States
(12) Patent Application Publication
(10) Pub. No.: US 2004/0043685 A1
(43) Pub. Date: Mar. 4, 2004

(54) Spunmelt hydrophilic nonwoven material and method of producing

(75) Inventors: Moshe Goldwasser, Tel Aviv (IL); Achai Bonneh, Kokhav Yair (IL)

Correspondence Address: Breiner & Breiner, L.L.C., P. O. Box 19290, Alexandria, VA, 22320-0290, US

(73) Assignee: Avgol Ltd., Holon (IL)

(21) Appl. No.: 10/229,093

(22) Filed: Aug. 28, 2002

(51) Int. Cl. B32B 3/02; B32B 3/10

(52) U.S. Cl. 442/61; 442/118

(57) ABSTRACT

A nonwoven material composed of hydrophobic material rendered hydrophilic through the inclusion of an internal additive is described. The nonwoven material includes at least one layer of which can be continuous filament spunmelt or meltblown. The layer can be provided alone or as one of a composite material. Hydrophilicity is imparted to the nonwoven material by inclusion of a surfactant additive in an extrusion melt during formation of fibers which will form a layer of nonwoven material. By controlling the internal additive utilized and modifying the type of fibers formed, e.g., continuous, non-continuous (staple), denier size, etc., the absorbency and barrier properties of a nonwoven material can be predetermined in view of the use to which the nonwoven material is to be applied.

### FIELD OF INVENTION

The invention is directed to a spunmelt nonwoven material which is hydrophilic, as well as a method of making such nonwoven material. The hydrophilic nonwoven material can be provided as a single layer (spunmelt or meltblown) or be provided in a composite material, such as a spunbond-meltblown-spunbond (SMS) nonwoven material. The hydrophilic nonwoven material is useful in personal care absorbent products, such as feminine hygiene products, diapers, adult incontinent products, medical products (e.g. gowns and surgical drapes), etc., as well as for absorbent wipes and the like.

### BACKGROUND OF THE INVENTION

Standard polyolefin based nonwoven products are hydrophobic in nature due to the water repellent nature of the polyolefin material from which nonwovens are generally made. Conventional nonwoven materials are thus generally useful as barrier material to prevent liquids from freely passing through the nonwoven material. Typical nonwoven structures can have a basis weight in a wide varying range, be a single or multiple layer product, and can be partially or completely, internally or topically, treated with a surfactant material to affect the hydrophobic properties of the nonwoven material. For example, U.S. Pat. No. 6,300,258 B1 discloses generally that a nonwoven web including a plurality of filaments made from one or more polymers, as utilized as a layer in forming a nonwoven single layer or multilayer composite, can have a basis weight ranging from about 0.1 gsm to 100 gsm (grams per square meter). These webs are recognized as being hydrophobic generally but also are recognized as being made hydrophilic upon treatment with a surfactant. The web can be a spunbond, meltblown or bonded carded web.

Further, a layer of a nonwoven material may be made of staple or discontinuous fibers or of continuous fibers. U.S. Pat. No. 6,183,847 B1 describes a one-piece web having a multicomponent structure including at least one discontinuous fine fiber layer having a meltblown content of greater than zero but less than 1.5 gsm. The discontinuous fine fiber layer is stated to enhance liquid containment and liquid transport within the one-piece web.

Accordingly, various combinations of materials are known. In view of the wide variety of uses for nonwoven materials requiring absorbency by the nonwoven material, such as in personal care and medical products as well as dry or wet wipes, provision of a nonwoven material which is hydrophilic in nature and a cost and time effective method for making such material would be advantageous.

### OBJECTS OF THE INVENTION

Accordingly, a primary object of the present invention is to provide a nonwoven material of controlled hydrophilicity.

More particularly, it is an object of the invention to provide a nonwoven material of a hydrophobic material, such as polyolefin, rendered hydrophilic by inclusion of an internal additive, in particular wherein the additive is a surfactant.

A further object is to provide a spunmelt hydrophilic nonwoven material which can be of continuous filaments, such as in a conventional spunmelt material, or can be a meltblown material of low denier fibers, non-continuous or staple fibers or a combination thereof. The nonwoven material can be a single layer or can be combined with other nonwoven materials to provide multilayer products. Such other layers may be hydrophilic or hydrophobic as desired depending of the end use of the product.

A further object is to provide a nonwoven material which based on the degree of hydrophilicity provided utilizing an internal additive and the nature of the filament structure can be customized to particular uses with regard to absorbency and barrier properties.

A further object is to provide a method of making such hydrophilic nonwoven material involving altering the fluid handling property of the nonwoven material with a surfactant additive to render the hydrophobic material hydrophilic, wherein the additive, in liquid or solid form, is added to an extruder prior to formation of the nonwoven material.

It is a further object of the invention to provide a hydrophilic nonwoven material which can act at least in part as a barrier against the migration or movement of solid particles or components contained in a product in which the nonwoven material is used.

### BRIEF DESCRIPTION OF THE INVENTION

A durable hydrophilic nonwoven material of the invention can be of spunmelt fiber or meltblown fiber, and can be present singly or with another nonwoven material to form a composite. The fibers of a layer can be continuous filaments of a conventional spunmelt material, or can be low denier fibers and/or non-continuous or staple fibers, such as is present in conventional meltblown material. The fibers are preferably a thermoplastic polymer, more preferably a polyolefin, and most preferably polypropylene. These materials by nature are hydrophobic. In the case of low denier fibers and/or non-continuous or staple fibers, water repellency of the hydrophobic fibers is increased due to the high surface area present.

The nonwoven material can be rendered hydrophilic in nature by including a suitable additive, in liquid or solid form, in the polymer to be extruded during production of one or more layers of nonwoven material. The additive is a surfactant. In particular, advantageous results have been obtained when the internal additive is of formula (I) and/or (II) as set forth below.

The internal additive in the polymer to be extruded for the formation of a nonwoven material preferably is of formula (I) and/or (II) as follows:

A—B—C—B—A (I)

A—B—A (II)

where

A is R—COO, where R is a saturated, unsaturated, branched or unbranched alkyl radical of 7 to 21 carbon atoms,

B is (CₙH₂ₙO)ₖ, where n is an integer from 2 to 4 and k is from 1 to 15, and

C is a linear or branched alkylene radical of at least 2 and at most 6 carbon atoms.

A surfactant within the above formulations is sold by Cognis Deutschland GmbH & Co. KG under the name Standapol 1480, and Standapol 1354.

The surfactant of formulas (I) and (II) are preferred and advantageous over other surfactant additives because of the durable hydrophilic properties of the surfactants, desirable fluid transport properties, high fluid absorbent capacity, and good strike-through and rewet properties.

The nonwoven fabrics of the invention are useful in a wide variety of applications. For example, the nonwoven material is useful as a component of absorbent products such as disposable diapers, feminine hygiene products, adult incontinent products; medical products such as surgical gowns, drapes and masks; disposable dry or wet wipes; industrial garments; filtration media; etc. In view of the controlled hydrophilic nature which can be imparted to a nonwoven material and the ability to also control the fiber structure provided (i.e., continuous, non-continuous, denier, single layer, multi-layer, etc.), the nonwoven material can be structured to include specific properties tailored to the use to which the nonwoven material will be applied. The degree of absorbency and barrier properties in particular can be controlled.

### BRIEF DESCRIPTION OF DRAWING

FIG. 1 is a schematic of the production method of a hydrophilic nonwoven material of the invention.

FIG. 2 is a schematic of an alternative production method of a hydrophilic nonwoven material of the invention.

### DETAILED DESCRIPTION OF PRESENTLY PREFERRED EMBODIMENTS

The nonwoven material of the present invention includes at least one layer which can be of continuous filament spunmelt fibers or meltblown fibers. The fibers forming the at least one layer are polymeric and can be continuous or non-continuous (staple fibers). The fibers can be made using conventional extrusion apparatus.

To provide the nonwoven as hydrophilic while retaining and improving high strength and improved processability, both during manufacture and after manufacture, the nonwoven material preferably has a basis weight of about 0.5 to 150 gsm (grams per square meter).

The fibers of each layer are made of a thermoplastic polymer. Suitable polymers include polyolefins, which are by nature hydrophobic, such as polypropylene and polyethylene; polyesters such as polyethylene terephthalate; polyamides; polyacrylates; polystyrene; thermoplastic elastomers; and blends of these and other known fiber forming thermoplastic materials. The preferred useful polymer is polypropylene in particular in the layer which will include the internal additive to render the material hydrophilic to a predetermined degree. When polypropylene is utilized with the preferred additive described below, advantageous results are obtained including the maintenance of fluid transport properties while maintaining barrier properties for solids and other particles; and fluid absorption properties without the need for using wood pulp or other more cost prohibitive materials such as viscose.

Hydrophilicity can be imparted completely to the nonwoven material by the inclusion of a solid or liquid additive to an extrusion of polymeric base material.

The method of the invention for making a hydrophilic nonwoven material will be described in relation to the figures. One advantage of the method of the invention is the provision of a layer of nonwoven material in a process which combines the manufacture of thermoplastic polymer fibers, the formation of a layer therefrom and, if desired, the combining of the formed layer with one or more additional layers so as to provide a finished multi-layer product in one manufacturing line. Alternatively, the invention can also be used to provide staple fibers made by a first process and used to form a product in the same or a separate process not requiring additional treatment to impart hydrophilicity to the layer formed from the staple fibers since the hydrophilic properties were imparted during manufacture and will be retained thereafter.

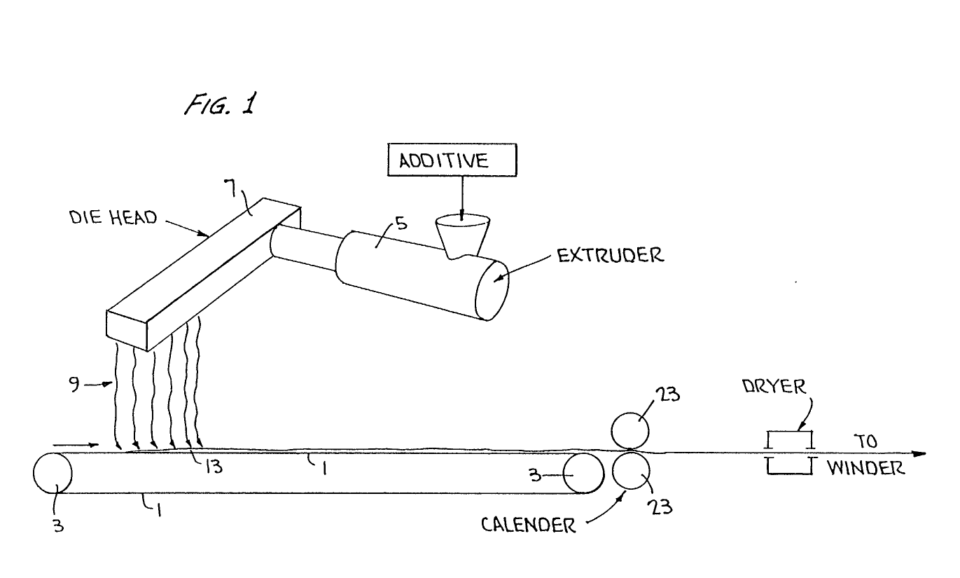

With reference to FIG. 1, a perforated belt 1 moving continuously along rollers 3 is provided beneath the exit orifices for extruder 5. Extruder 5 receives an additive which is extruded through a substantially linear diehead 7 to form a plurality of continuous or non-continuous fibers 9 which randomly fall to belt 1 to form a layer 13 thereon. The extrusion apparatus and general process parameters used are as known to one skilled in the art except as further defined herein. The diehead includes a spaced array of die orifices having diameters of preferably about 0.1 to about 1.0 millimeters (mm). The filaments following extrusion are quenched and drawn, such as by cooling air. The filaments extruded can be continuous in a spunmelt manner. Alternatively, the filaments can be meltblown and be continuous or non-continuous. Further, continuous fibers may be cut to provide staple fibers. With meltblown fibers the denier can be low, such as from about 0.5 to about 20 microns.

The polyolefin material from which the extruded filaments are made is hydrophobic in nature. The polyolefin material is conventionally added to an extruder 5 in the form of pellets. In accordance with the invention, an additive is incorporated into the extrusion polymeric melt so as to act as an internal additive to the polymeric material and thus render the material and the nonwoven made therefrom hydrophilic in nature. To provide for sufficient admixture and to render the polymeric material hydrophilic, the additive and the polymer are present in a ratio of from about 0.2 to about 4 percent based on active ingredients at the time of addition. Extrusion parameters suitable for use include heating at a temperature of from about 170° C. to about 310° C. with a residence time in the extruder from about 0.5 to about 5 minutes prior to extrusion through the diehead. The degree of hydrophilicity can be controlled by the amount of additive utilized and/or the percentage of active ingredient in the additive.

The preferred additives, which are most advantageously utilized with polypropylene, have a formula (I) and/or (II) as follows:

A—B—C—B—A (I)

A—B—A (II)

where A is R—COO, where R is a saturated, unsaturated, branched or unbranched alkyl radical of 7 to 21 carbon atoms,

B is (CₙH₂ₙO)ₖ, where n is an integer from 2 to 4 and k is from 1 to 15, and

C is a linear or branched alkylene radical of at least 2and at most 6 carbon atoms.

The additive can be either (I) or (II) alone or a combination of (I) and (II) together. The additive is sold under the name Standapol 1480 and Standapol 1354 by Cognis Deutschland GmbH & Co. KG.

Preferred additives of formula (I) are where R is a saturated linear alkyl radical of 9 to 13 carbon atoms; more preferably 9-11 carbon atoms; k is from 1 to 15, more preferably from 4 to 10, and most preferably 5; C is CH₂—CH₂, CH₂—CH(CH₃), CH₂—CH₂—CH₂ or (CH₂)₄; and n is 2. Preferred combinations for formula (I) are (1) R is a linear alkyl of 9 carbon atoms, k is 5, n is 2 and C is CH₂—CH₂(CH₃); and (2) R is a linear alkyl radical of 11 carbon atoms, k is 5, n is 2 and C is CH₂—CH₂(CH₃). Compounds of formula (I) have a temperature cloud point of less than 12° C., preferably less than 10° C. and most preferably less than 6° C. Preferred compounds of formula (II) are prepared by reacting two parts of fatty acids of 8 to 22 carbon atoms with one part polyethylene glycol, most preferably two parts of fatty acids of 10 to 12 carbon atoms with one part of polyethylene glycol. The reaction produces polyethylene glycols having molecular weights of 300 to 600, preferably 400 to 500.

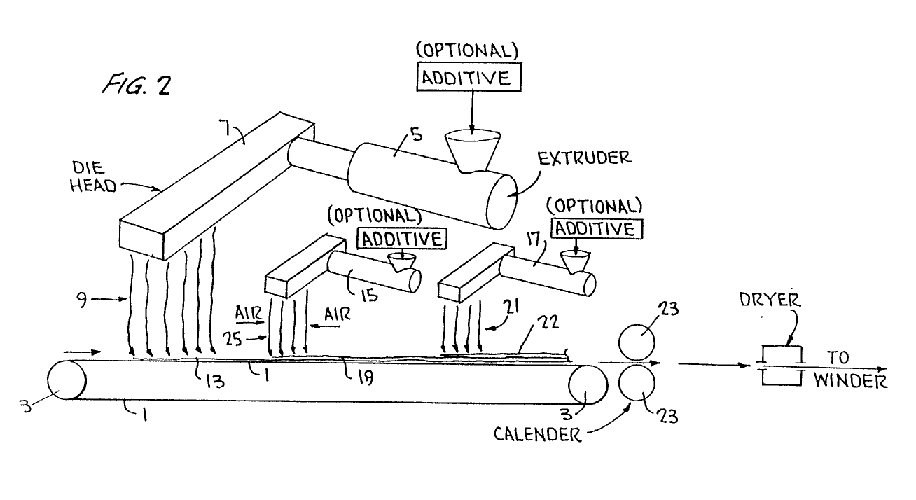

As an alternative or complement to making a single layer of hydrophilic nonwoven material as described above, additional extruders can be positioned in relation to the belt 1 upstream or downstream in the processing direction to extruder 5 to provide spunmelt or meltblown fibers. For example, as shown in FIG. 2, multiple extruders 5, 15, 17 can be positioned along belt 1. An internal additive can be incorporated into the polymer melt of one or more of the extruders depending upon the end product sought. Extruders 5 and 17 may provide spunmelt fibers and extruder 15 may provide meltblown fibers thereby providing along belt 1 layers 13, 19 and 22, where a subsequent layer is formed on top of a preceding layer. Thereafter, the multiple layers can be subjected to any one of a number of commercially known methods used to join or bond filaments and layers together, such as calender rolls 23 as illustrated for example. The product is then subjected to conventional drying and winding.

In meltblowing, a thermoplastic polymer, preferably polypropylene, is fed into an extruder where it is melted and heated sufficiently to form fibers from the polymer. The molten polymer is fed to an extrusion diehead having a spaced array of die orifices. The orifices preferably have a diameter from about 0.1 to 0.5 mm. The polymer issues as molten streams of fibers 25 into converging streams of a heated gas, such as air. The air attenuates the stream of fibers which fall to belt 1 and are laid in the process upon layer 13 forming a second layer 19. The meltblown fibers are entangled as they fall to provide a cohesive layer.

Extruder 19 further positioned downstream may for example make additional fibers 21, such as continuous spunlaid fibers. Fibers 21 randomly fall to belt 1 and are laid atop layer 19 to form a third layer 22. Thus along one conveyor line a spunbond-meltblown-spunbond (SMS) nonwoven material can be provided wherein one or more layers thereof may contain the internal additive of the invention to thereby provide a hydrophilic nature to the nonwoven material and product made therewith.

As described above, the layers can be bonded by being passed through calender rolls 23 to join the layers together by mechanical interlocking. Other conventional processes such as thermal bonding, adhesive bonding, hydroentanglement, needle punching and the like, are also suitable for use.

The nonwoven material of the invention is particularly suitable to act as a barrier against movement or migration of solid particles. For example in baby diapers, adult incontinent products and feminine hygiene products, superabsorbent polymers (SAPs) are commonly used. The SAPs are required to stay positioned in a certain area of the product for the product to effectively serve its intended purpose. The nonwoven material of the invention, due to its structure being both lightweight and capable of being made as a tight filament structure, is particularly effective as a barrier without adding undesirable bulk or weight.

As will be apparent to one skilled in the art, various modifications can be made within the scope of the aforesaid description. Such modifications being within the ability of one skilled in the art form a part of the present invention and are embraced by the appended claims.

It is claimed:

1. Method of producing a hydrophilic nonwoven material including at least one layer, said method comprising providing a first extrusion thermoplastic polymeric material and combining with a surfactant additive, extruding said material combined with said additive to form fibers and forming therefrom a first layer of hydrophilic spunmelt or meltblown fibers; wherein the surfactant additive has a formula (I) and/or (II) as follows:
A—B—C—B—A (I)
A—B—A (II)
where A is R—COO, R being a saturated, unsaturated, branched, unbranched alkyl radical of 7 to 21 carbon atoms,
B is (CₙH₂ₙO)ₖ, n being from 2 to 4 and k being from 1 to 15, and
C is a linear or branched alkylene radical of at least 2 and at most 6 carbon atoms,
wherein the fibers can be continuous or made to be non-continuous.

2. Method according to claim 1, wherein R in the formula (I) is a saturated linear alkyl radical of 9 to 13 carbon atoms.

3. Method according to claim 1 or 2, wherein k in the formula (I) is from 1 to 15.

4. Method according to claim 1 or 2, wherein C in the formula (I) is CH₂—CH₂, CH₂—CH(CH₃), CH₂—CH₂—CH₂ or (CH₂)₄.

5. Method according to claim 3, wherein C in the formula (I) is CH₂—CH₂, CH₂—CH(CH₃), CH₂—CH₂—CH₂ or (CH₂)₄.

6. Method according to claim 1 or 2, wherein n in the formula (I) is 2.

7. Method according to claim 1, wherein R in the formula (I) is a linear alkyl radical of 9 carbon atoms, k is 5, n is 2 and C is CH₂—CH₂(CH₃).

8. Method according to claim 1, wherein R in the formula (I) is a linear alkyl radical of 11 carbon atoms, k is 5, n is 2 and C is CH₂—CH₂(CH₃).

9. Method according to claim 1, wherein compounds of the formula (I) have a low temperature cloud point of less than 12° C.

10. Method according to claim 1, wherein compounds of the formula (II) are prepared by reacting two parts of fatty acids of 8 to 22 carbon atoms with one part of polyethylene glycol.

11. Method according to claim 10, wherein the compounds of the formula (II) are prepared by reacting two parts of fatty acids of 10 to 12 carbon atoms with one part of polyethylene glycol.

12. Method according to claim 10 or 11, wherein the reaction produces polyethylene glycols having molecular weights of 300 to 600.

13. Method according to claim 1, further comprising
providing a second extrusion thermoplastic polymeric material, extruding said material to form continuous filament spunmelt or meltblown fibers, and forming therefrom a second layer of fibers;
optionally, providing a third extrusion thermoplastic polymeric material, extruding said material to form continuous filament spunmelt or meltblown fibers, and forming therefrom a third layer of fibers; and
bonding said first layer, said second layer and said third layer, when present, to provide a combined structure.

14. The method according to claim 1 or 13, wherein said extrusion thermoplastic polymeric material comprises a polyolefin.

15. The method according to claim 14, wherein said polyolefin is polypropylene.

16. The method according to claim 13, wherein one or both of said second extrusion thermoplastic polymer material and said third extrusion thermoplastic material are combined with a surfactant additive.

17. The method according to claim 16, wherein said surfactant additive has a formula of (I) or (II).

18. The method according to claim 13, wherein said bonding is by calendering, heating, adhesive, hydroentanglement or needle punching.

19. The method according to claim 1 or 16, wherein said additive is present in a ratio of additive to thermoplastic material of from about 0.2 to about 4 percent of active ingredient.

20. The method according to claim 1 or 13, wherein said extrusion takes place at a temperature of from about 170° C. to about 310° C.

21. The method according to claim 1 or 13, wherein said thermoplastic material and said additive have a residence time in an extruder of from about 0.5 to about 5 minutes.

22. The hydrophilic nonwoven material produced by the method of claim 1, 7, 8, 10, 13, 16 or 17.

23. The hydrophilic nonwoven material produced by the method of claim 15.

24. A hydrophilic nonwoven material composed of at least one layer including fibers comprising a thermoplastic polymer and an internal surfactant additive of formula (I) and/or (II) as follows:
A—B—C—B—A (I)
A—B—A (II)
where A is R—COO, R being a saturated, unsaturated, branched, unbranched alkyl radical of 7 to 21 carbon atoms,
B is (CₙH₂ₙO)ₖ, n being from 2 to 4 and k being from 1 to 15, and
C is a linear or branched alkylene radical of at least 2 and at most 6 carbon atoms.

25. Nonwoven material according to claim 24, wherein R in the formula (I) is a saturated linear alkyl radical of 9 to 13 carbon atoms.

26. Nonwoven material according to claim 24 or 25, wherein k in the formula (I) is from 1 to 15.

27. Nonwoven material according to claim 24 or 25, wherein C in the formula (I) is CH₂—CH₂, CH₂—CH(CH₃), CH₂—CH₂—CH₂ or (CH₂)₄.

28. Nonwoven material according to claim 26, wherein C in the formula (I) is CH₂—CH₂, CH₂—CH(CH₃), CH₂—CH₂—CH₂ or (CH₂)₄.

29. Nonwoven material according to claim 24 or 25, wherein n in the formula (I) is 2.

30. Nonwoven material according to claim 24, wherein R in the formula (I) is a linear alkyl radical of 9 carbon atoms, k is 5, n is 2 and C is CH₂—CH₂(CH₃).

31. Nonwoven material according to claim 24, wherein R in the formula (I) is a linear alkyl radical of 11 carbon atoms, k is 5, n is 2 and C is CH₂—CH₂(CH₃).

32. Nonwoven material according to claim 24, wherein compounds of the formula (I) have a low temperature cloud point of less than 12° C.

33. Nonwoven material according to claim 24, wherein compounds of the formula (II) are prepared by reacting two parts of fatty acids of 8 to 22 carbon atoms with one part of polyethylene glycol.

34. Nonwoven material according to claim 33, wherein the compounds of the formula (II) are prepared by reacting two parts of fatty acids of 10 to 12 carbon atoms with one part of polyethylene glycol.

35. Nonwoven material according to claim 33 or 34, wherein the reaction produces polyethylene glycols having molecular weights of 300 to 600.

36. Nonwoven material according to claim 24, wherein said thermoplastic polymer is a polyolefin.

37. Nonwoven material according to claim 36, wherein said polyolefin is polypropylene.

38. Nonwoven material according to claim 24, wherein said nonwoven material comprises a component of a personal care, medical or wipe product.
